(19) United States
(12) Patent Application Publication
(10) Pub. No.: US 2002/0082769 A1
(43) Pub. Date: Jun. 27, 2002

(54) Airport auditing and information system

(76) Inventors: Gary Church, Springfield, VA (US); E. Ann Berman, McLean, VA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/989,637

(22) Filed: Nov. 20, 2001

Related U.S. Application Data
(60) Provisional application No. 60/252,355, filed on Nov. 21, 2000.

(51) Int. Cl. G06F 19/00

(52) U.S. Cl. 701/120; 342/36; 348/149

(57) ABSTRACT

A system for detecting at least one aircraft comprises at least one illuminator capable of providing at least one light from the group consisting of visible light and near infrared light; at least one camera capable of providing a daytime image of the aircraft, the video camera being capable of providing a nighttime image of the aircraft if the aircraft is illuminated by the illuminator; a mechanism for detecting when the at least one aircraft moves; a processor for identifying a tail number of the at least one aircraft based on alphanumeric data in at least one image from the group consisting of the nighttime image and the daytime image; and a storage medium that stores the tail number of the aircraft and the least one image when the detecting means detects movement of the aircraft.

This application claims the benefit of U.S. Provisional Patent Application No. 60/252,355, filed Nov. 21, 2000.

### FIELD OF THE INVENTION

The present invention relates to detection systems generally, and more specifically to detection systems for identifying aircraft activity in airports.

### BACKGROUND OF THE INVENTION

Accurate information on aircraft activity at airports is of significant concern to airport owners and operators as well as to those responsible for planning, developing, and administering these facilities.

Historically, the process of gathering airport operation counts has been relatively imprecise. Current procedures for collecting counts rely on visual observations, pneumatic tube counters, inductance loop counters, and acoustical counters. Each method has its strengths and weaknesses in terms of accuracy, cost, ease of use, and ability to collect additional information about operations. Methods also differ in their suitability to the particular airport being sampled.

Large commercial aircraft are equipped with a transponder, that when interrogated, returns the aircraft tail identification number. This “cooperative” technology is not required by regulatory authorities on smaller aircraft and general aviation aircraft. Additionally, the transponder can be inadvertently turned off on larger commercial aircraft.

U.S. Pat. No. 5,375,058 to Bass describes a system that utilizes multiple infrared scanners and presence / absence) detectors in close proximity to runways and taxiways. It can track aircraft and vehicles using bar-coding identification. Data from these scanners and detectors is processed and displayed on a digital map of the airport. It utilizes aircraft tail numbers as an index but relies on a “master host memory” which contains flight numbers, aircraft characteristics, and the like.

An improved surface detection system is desired.

### SUMMARY OF THE INVENTION

One aspect of the invention is an automated method for detecting at least one aircraft, comprising the steps of: (a) automatically detecting a movement of at least one aircraft within the area, regardless of a time of day when the movement occurs; (b) forming at least one image of the aircraft when the movement is detected; (c) automatically identifying a tail number of the at least one aircraft based on alphanumeric data in the least one image; and (d) automatically storing the tail number of the aircraft and data characterizing the aircraft in a database.

Another aspect of the invention is a system for detecting at least one aircraft, comprising: at least one camera capable of providing an image of the at least one aircraft; means for detecting when the at least one aircraft moves; means for identifying a tail number of the at least one aircraft based on alphanumeric data the image; and a storage medium that stores the tail number of the aircraft and the image when the detecting means detects movement of the aircraft.

### BRIEF DESCRIPTION OF THE DRAWINGS

FIG. 1 is a block diagram of an exemplary system according to the invention.

FIG. 2 is a diagram of an airport in which the system of FIG. 1 is installed.

FIG. 3 is a detailed block diagram showing one of the camera signal processors and the on-site processor of FIG. 1.

FIG. 4 is a block diagram showing the central processor of FIG. 1.

FIG. 5 is a block diagram of a power subsystem as shown in FIG. 1.

FIG. 6 is an exemplary report provided by the central processor of FIG. 1.

FIG. 7 is a flow chart diagram of an exemplary method according to the present invention.

### DETAILED DESCRIPTION

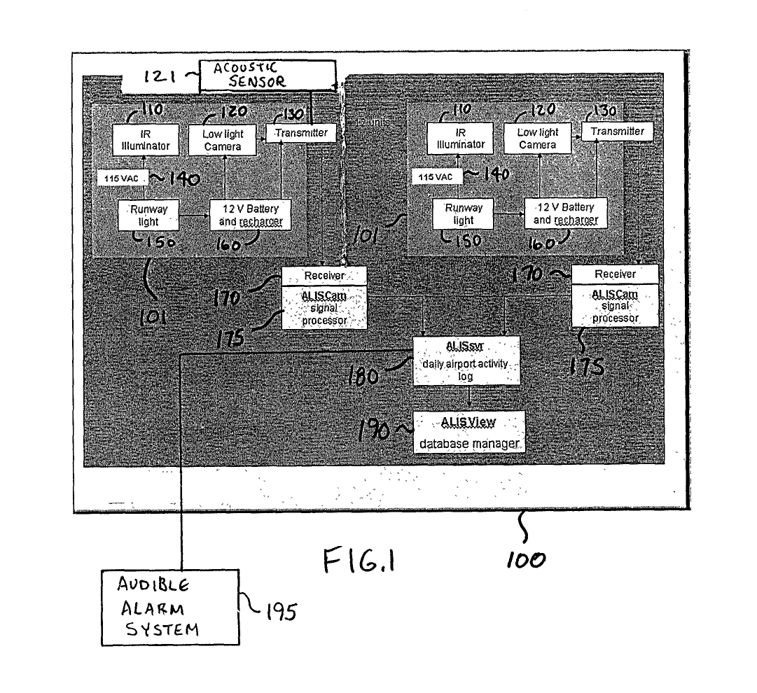

FIG. 1 is a block diagram of an exemplary system 100 in accordance with the present invention. The exemplary “AIRPORT AUDITING AND INFORMATION SYSTEM (AAIS)™” 100 includes at least one illumination source 110 for illuminating objects at an airport which may potentially be aircraft 202, at least one imager (e.g., camera) 120 capable of taking both day and nighttime imagery of the objects, at least one processor 180 for processing images to detect arrivals, departures and touch-and-go's, and a storage means 180 for storing the detection data. (A touch-and-go is a landing and takeoff that occurs without stopping. It is practiced during pilot training exercises.)

The system 100 is designed to provide airport management with:

An automated means of identifying and tracking aircraft arrivals and departures

A method of reporting aircraft operations with improved accountability

Automated invoicing for landing and parking fees

Aircraft noise reporting data

Reports of all relevant aircraft information including tail number, maximum landing and take-off weights, engine types, fuel loads, and ownership.

The system 100 provides accurate counts of aircraft activity on airport surfaces by tail number using non-cooperative surveillance technology (i.e., no action or signal by the airplane or its pilot is required to complete an identification). Exemplary system 100 does not require any bar code or special format to be used on the aircraft 202 to indicate the tail numbers. Rather, Arabic numerals and/or alphabetic characters are decoded from an image of the tail of aircraft 202, using optical character recognition.

The near infrared video cameras 120 capture prominent aircraft 202 features already a part of the aircraft 202 (i.e., FAA required and displayed tail numbers). These tail numbers may be used for auditing and invoicing, and are not limited to any security or safety application. System 100 may also use acoustic sensors 121 for environmental profiling.

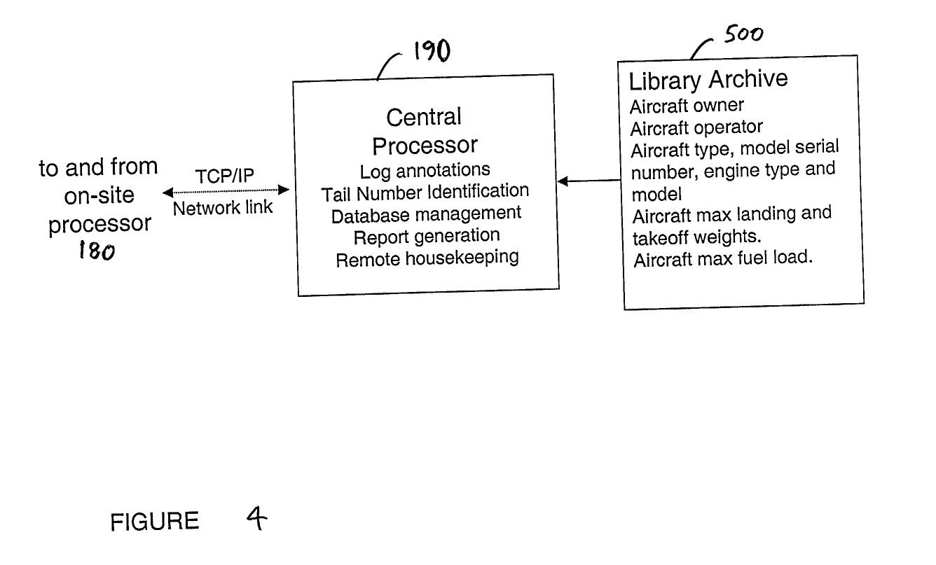

The system 100 is designed to operate 24 hours a day in all weather conditions. It locally captures, records and transmits data concerning aircraft 202 movements including arrivals, departures, touch-and-go's, and parking. System 100 provides security records for ramp and aircraft movement areas. It centrally processes images, builds an aviation database and generates reports. It correlates the tail number identification with a central database archive 500 (shown in FIG. 4) of aircraft operators to provide for landing and parking fee invoicing and other reports that might be required by the airport management authority.

Counts of airport activities can be correlated with operating costs and may be used for planning capital facilities improvements. Knowledge of aircraft identification number is even more valuable than counts alone because aircraft ID can be correlated with related information for a variety of purposes such as fuel use, billing, noise abatement, and air pollution abatement. Because non-cooperative technology is used to gather information, the system is of value for security reasons as well. Any object that passes in front of the camera is logged and recorded.

The exemplary visual system 102 uses at least one video camera 120 and integrated software (described below) to detect motion and capture an image. The detection algorithms are adjustable to establish parameters of size, contrast and movement so that small bird movements are ignored, yet pedestrians, animals, vehicles and aircraft 202 trigger an event detection. Placement of the cameras 120 as well as lenses can adjust detection range and fields of view.

The system 100 automatically captures an image of aircraft tail numbers, both at day and night, of every aircraft 202 moving to and from each airport runway. These images are stored and forwarded via a network connection (e.g., a proprietary wide area network, or the Internet) to a central processor 190, where the aircraft 202 identification or tail numbers are recognized and entered into a database containing information from Federal Aviation Administration and proprietary databases.

A permanent image of every aircraft operation (arrival, departure, or touch-and-go), which identifies aircraft tail numbers, provides for complete record of accountability for all aircraft operations conducted twenty-four hours a day, seven days a week. Furthermore, knowing the unique aircraft tail number enables a detailed level of reporting associated with specifics of aircraft 202, engines and ownership. Reports can be generated periodically to provide a complete and detailed record of aircraft activity.

The exemplary system minimizes all maintenance requirements. There are only two user-serviceable parts, the infrared illuminator lamp of illuminator 110, and the gel cell batteries 160.

Since the exemplary camera 120 is sensitive to near infra-red as well as visible, ambient light, camera 120 is augmented with near infrared floodlights 110, providing light invisible to the human eye, to ensure that images are detected and captured, even in total darkness.

Reference is again made to FIG. 1. The exemplary system 100 has a set of up to 12 imaging subsystems 101. Each subsystem 101 includes a large format video camera 120, a real-time wireless transmit/receive apparatus 130 and a power system. The exemplary power system includes an alternating current (AC) voltage source 140, a runway lighting system 150 and a battery/recharger system 160. Preferably, the camera 120 and transmitter 130 are battery powered, and the battery 160 is recharged nightly using the runway lighting system 150. This configuration makes use of existing AC power lines. It is understood that dedicated AC power lines may be used as an alternative.

In the preferred embodiment, a live video signal is broadcast to the on-site processor 180 in real-time, on a continuous basis. The broadband transmitter 130 has sufficient bandwidth to transmit an uncompressed video signal, which is about 10 Mhz bandwidth.

The exemplary system 100 has a central processor 190 that receives up to 12 video data streams in real-time and processes them to detect change in the field of view of each camera 120. An initial rudimentary classification is done on the change area to determine the general cause of image change. This is sufficient to determine whether the detected event is an arrival, a departure, a touch-and-go, or a parking activity. Significant change-areas are sent on for further processing, including aircraft identification by tail number.

The use of visual detection of the presence of humans, animals, vehicles or aircraft 202 in the vicinity of an airport landing area is a potentially ideal detection solution for small (i.e., less than 10,000 annual operations), medium sized airports (i.e., up to 250,000 annual operations) and in some cases large airports (i.e., 250,000 to 350,000 annual operations). This low-cost system can be easily coupled with a myriad of other sensors (i.e., loop, infrared, ultra-violet, radar, transponders, acoustical) as well as numerous alerting systems (i.e., runway status lights, PAPI and VASI, “SUPERUNICOM™,” etc.) to optimize unique airport requirements and costs.

The ability to deploy up to twelve camera detectors 120 at strategic remote locations with detection ranges in the hundreds of feet range, make this system ideal for detection of large animals (i.e., deer) as well as other vehicles in the near vicinity of an active runway that do not necessarily operate on designated taxiways. Depending on runway and taxiway configurations, airports with up to three runways and multiple taxiways can have comprehensive visual detection.

Although the exemplary system 100 is sized for up to 12 cameras 120, it is contemplated that systems based on the principles disclosed herein may include any desired number of cameras, to adapt to larger sized airports. It is understood that corresponding changes to the control and reporting software may be necessary to accommodate larger numbers of cameras.

The exemplary visual detection system may be used in any location, except possibly the most extreme conditions north of the Arctic Circle or in Antarctica. Cameras 120 is preferably mounted at a ground height of 66 centimeters (26 inches) and can contain internal heating elements within an environmentally sealed unit. Alternatively, camera 120 may be mounted on other surfaces, such as a rooftop, and may be mounted at different heights.

The system 100 provides an automated record of each image capture time to the second as well as a record of camera location. This imaging data associated with the image itself permits a determination of arrival or departure time and runway, as well as a validation of aircraft 202 type and any commercial operator livery.

Once the information is transmitted to the central database in central processor 190, the aircraft tail number is matched to other government and private database records to determine additional information such as aircraft 202 owner from the FAA Aircraft and Airmen Registry of active registered aircraft and licensed airmen.

An additional service that can be made available is aircraft noise reporting. Once the information is transmitted to the central database, the aircraft tail number is matched to government records to determine additional information such as aircraft noise level (EPNdB) and classification (Stage) from FAA Advisory Circular 36-1G and 36-3G as well as from FAA certification data. An acoustical sensor may be used for measuring sound levels, and these sound levels may be correlated with the tail number.

After the imaging information is transmitted to the central database of central processor 190, the aircraft tail number is matched to other database records to generate automated invoicing for landing and parking fees. The fee schedules, which define who and how much is to be invoiced, are provided by the airport and fees are then automatically calculated and summarized and resultant invoices generated and mailed. Associated reports are also provided to the airport. Unless otherwise specified, payment is made directly to the airport and the airport is responsible for fee collection. One of ordinary skill in the art can readily construct the invoicing system to generate an invoice in response to a message identifying the owner of the aircraft, the type of aircraft, and the type of activity.

Once the information is transmitted to the central database, the aircraft tail number is matched to other government and private database records to determine additional information such as maximum landing and takeoff weights from FAA Advisory Circular 150/5300-13, FAA certification data, and commercial sources, such as Janes's All the World's Aircraft and AvData, Inc.

On-site Computer Processor: The on-site computer processor 180 performs multiple functions including receiving up to four NTSC video streams 505, grabbing, time-stamping and logging images of airplanes in the field of view. Events from each camera 120 are sent to resident server software that subsequently transmits daily event log and daily event imagery to a central processor 190 for further processing. A computer can readily be equipped to receive up to four camera data streams. Thus, in the exemplary embodiment, one on-site computer processor 180 is included for each four-camera unit. The computer has a minimum processing speed of 700 MHz and 128 Mbytes of RAM. The airport provides one dedicated phone line for each On-site Computer Processor 180 on site.

The visual detection capability of system 100 may optionally be coupled with the pilot voice communication of “SUPERUNICOM™” 195 (by Potomac Aviation Technology Corp. of Ft. Washington, Md.) to address runway incursion concerns at literally hundreds of small non-towered airports or airport during non tower operating periods. This elegant low cost composite solution provides an audible alert over an approved air traffic control frequency which every pilot either on the ground or in the air should be monitoring. Because the system is not directed to airborne collision but runway incursion, the approach is to alert the pilot if any hazardous movement of a potentially dangerous nature is approaching an active runway at any time.

Optionally, the exemplary surface surveillance information may be integrated with the “SUPERUNICOM™” audio broadcast system 195 (which automatically provides audio messages to pilots concerning airport conditions, alerts and instructions). An example of an audio message might be “Caution, snow plow operating on runway 01. Conditions favor runway 2.” The preferred reporting criterion is to broadcast only 100 percent positive surface movement events. Thus all false positives, as well as a minimal number of missed movements, are dropped from the event cue. This design objective tends to minimize the number of missed movements while at the same time eliminating all false positives. This is achieved by iteratively simplifying the classification scheme. It is also contemplated that the system can be used to broadcast surface movement events where there is a lower likelihood (e.g., 90% likelihood) of positive event detection.

Communication of an event is transmitted from the remotely located visual detection system via a transmitter (preferably using commercially open frequencies at 2.4 GHz or 5.8 GHz) to a central processor collocated with the “SUPERUNICOM™” 195. This event can be coded as to the location of the detected movement. A variation of the exemplary embodiment includes the optional capability of automatic aircraft call sign recognition which could be communicated via “SUPERUNICOM™” 195 in conjunction with an alert; for example, the alert could indicate that “N 1234” is operating on or in close vicinity of an active runway.

The exemplary system 100 supports twelve (12) remote cameras 120 within at least a one (1) mile radius of the central processing receiver antenna 170 to be collocated with a “SUPERUNICOM™” 195. The “SUPERUNICOM™” system 195 can provide alerts to aircraft and vehicles (snowplows, mowers, airport inspection vehicles, etc.) monitoring an air traffic control frequency (i.e., unicorn, common traffic advisory frequency, etc.). These alerts may be customized as to phraseology and content based on the particulars of the alerts communicated to the “SUPERUNICOM™” 195 from remote detectors.

Through the use of the exemplary visual detection system 100 and the associated communication capability of the “SUPERUNICOM™” 195 to broadcast runway safety advisories via a designated and monitored air traffic control (ATC) frequency, situational awareness can be maintained by pilots in the air and on the ground as well as by operators of ground vehicles operating on and in the vicinity of a runway using inexpensive ATC radio receivers.

Alternatively, other alarm systems may be used to provide visible and/or audible information and alerts to pilots, based on the detection of movement by cameras 120.

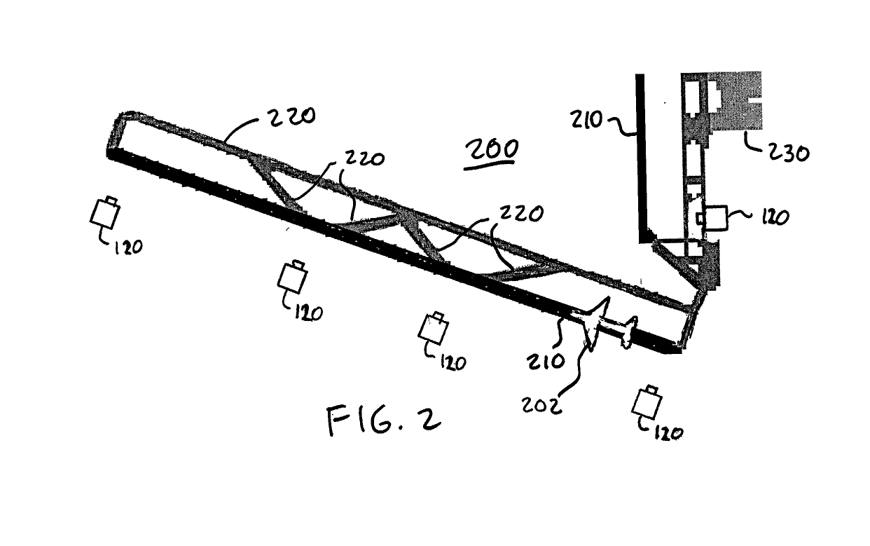

FIG. 2 is an example of possible locations for cameras 120 along a runway 210. Cameras 120 are located at ingress and egress points so that all take-offs, landing, and touch-and-go's are detected. Cameras 120 can also be located in and near ramp areas 230 to detect and identify parking aircraft 202. Camera equipment is located outside airport runway and taxiway obstacle free zones and safety areas. The preferred height off the ground is no more than 66 centimeters (26 inches). The preferable distance from the aircraft path is from 15 to 45 meters (50 to 150 feet). Camera mounts are fixed and the field of view set to capture aircraft tail numbers. All new aircraft 202 have tail numbers that are one foot high. Numbers on old aircraft can be 10 to 15 centimeters (four to six inches) high. There are usually six numbers or letters in a tail number. Therefore the field of view of the camera is set to cover a width of about 4.5 meters (15 feet) at the distance where the aircraft 202 traverses the field of view.

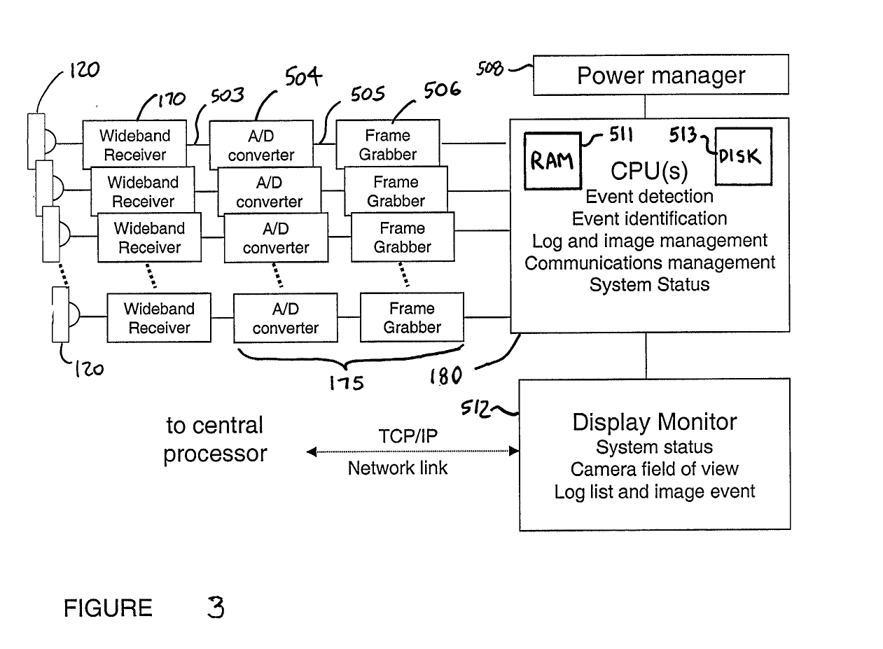

FIG. 3 shows the on-site processor 180 and a plurality of camera subsystems 101. There is a respective broad band receiver 170 and signal processor 175 for each camera subsystem 101. Signal processor 175 includes an analog/digital converter (ADC) 504 and a frame grabber 506. The real-time analog video imagery 503 is converted to digital frames 505 by ADC 504. The digital frames 505 are captured in random access memory (RAM) 511 of computer 180 using a frame grabber 506. The video signal from each camera is also sent to the monitor 512, where it can be viewed.

In the exemplary embodiment, the camera image is not recorded to the hard drive 513 unless aircraft motion is detected. The motion of the aircraft 202 across the field of view is used to trigger the camera 120 to record the event in a “trip-wire” operational concept. The recording trigger can be from the camera image itself or from an external trip-wire such as a laser, acoustic sensor, or inductance loop. The preferred detection means in on-site processor 180 triggers storage of an event based upon motion detected in the real-time video imagery by differencing sequential frames as they are grabbed off the live video stream 505. Preferably, cutoffs, based on the intensity of the change area in the difference image and on the size of the change area, are user selectable.

Images of aircraft events are saved in a date-coded log directory on the hard drive 513 of the on-site processor 180. The on-site processor 180 records images of aircraft events in sufficient resolution to read the tail number. All events are assigned a unique identification number. A daily log is created in the on-site processor 180 that includes the event identification number, an image of the event, the location where the event was observed, and the time it was observed.

The on-site processor 180 contains communications algorithms to establish a TCP/IP network connection to a central processor 190. Periodically, the event log and imagery are transmitted across the network link to the central processor 190. The event log can also be transmitted over a private wide area network (WAN) or local area network (LAN). In the exemplary embodiment, daily log files are retained in hard drive 513 of on-site processor 180 for up to 31 days. Longer retention periods may be implemented by providing a larger hard disk 513, and using a database capable of storing a larger number of frame data.

The on-site processor 180 is capable of monitoring and displaying the status of the camera subsystems 101. In the exemplary configuration, the status of the camera 120 is monitored by viewing the live video stream. The status of the receiver power can be interrogated. In an alternative embodiment the status of the transmitter and camera power, and the recharge status of the battery 160, are monitored from the on-site processor 180 as well.

The power manager 508 at the on-site processor 180 has surge protection and power backup sufficient to run the system during short power outages. Backup power may be provided by a commercially available uninterruptible power supply.

FIG. 4 shows the components and functions of central processor 190. In the central processor 190, the event log is annotated to include tail number, aircraft movement status, aircraft or object type, and carrier. Aircraft movement status refers to landing, takeoff, touch-and-go, or parking. Aircraft or object types include general aviation, air taxi, commuter, air carrier, military, other vehicle, human, and animal. All annotations are entered by a human operator. The tail number identifying means include an automatic character recognition algorithm, which includes a sequence of edge detection and matched filter algorithms. The tail number identifying means is used to assist the human operator. In an alternative embodiment, a “search and suggest” routine to identify frequently identified aircraft tail numbers may also be added to assist the operator.

Finally, the tail identification number is then correlated with a proprietary library archive 500 that contains information such as aircraft owner, operator, type, model, serial number, engine type, maximum landing and takeoff weights, and fuel load. The correlation means may include conventional relational database technology, for example. The results of this correlation are used to produce a variety of products such as fuel use, billing, noise abatement, and air pollution abatement reports. Commercially available spread sheet and database software, such as “EXCEL™” and “ACCESS™”, respectively, marketed by Microsoft Corporation of Redmond, Wash., may be used for report generation.

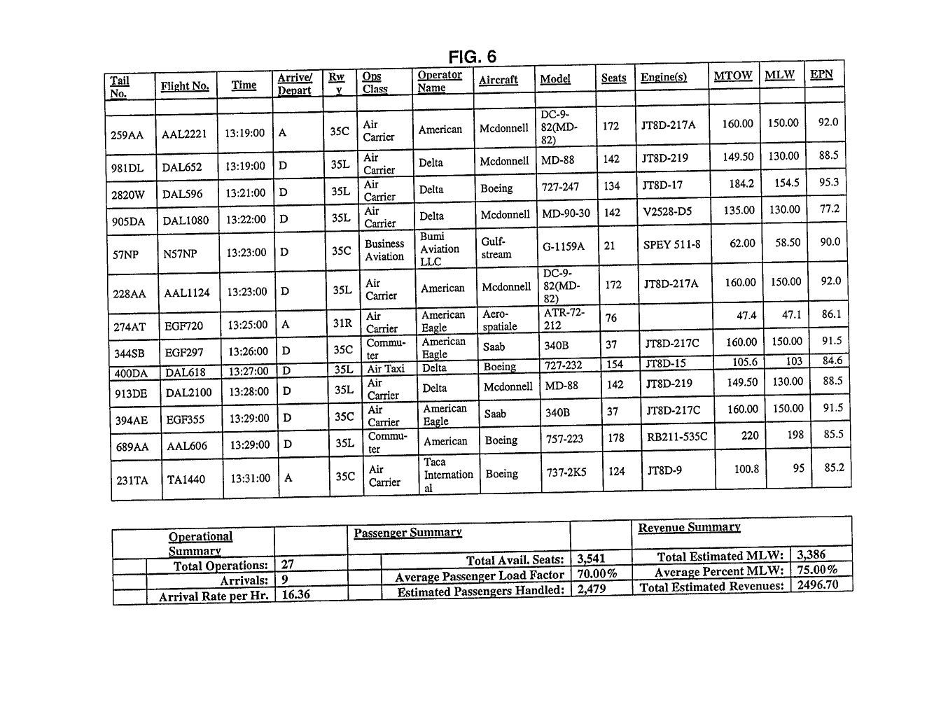

FIG. 6 is a table showing an exemplary event log report. It is understood that any desired report format may be provided.

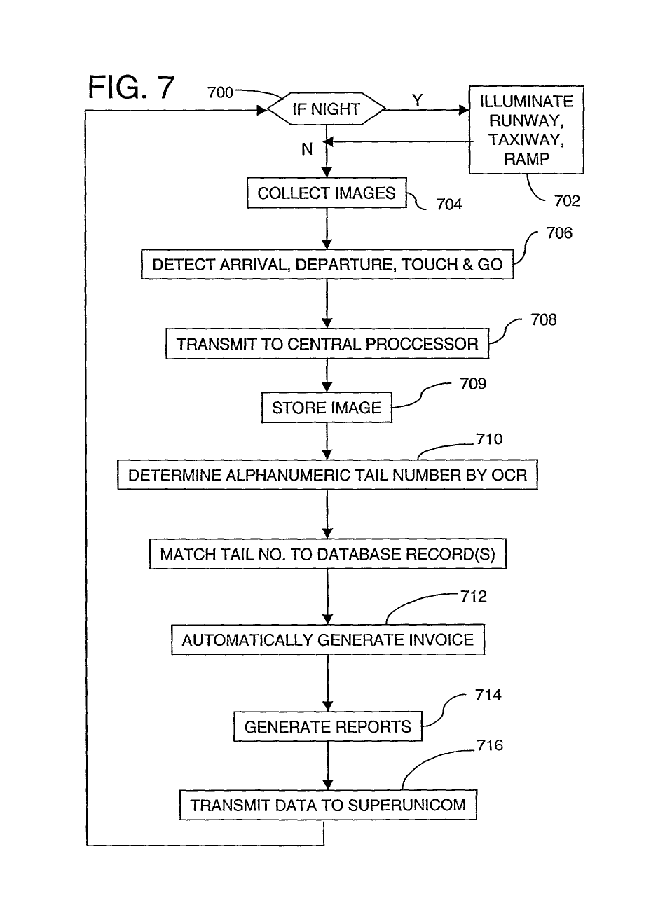

FIG. 7 is a flow chart diagram showing an exemplary method for using system 100. Imagery can be collected 24 hours per day. At step 701, a determination is made whether illumination is required. This determination may be made by a timer, or by a photosensor. At step 702, if it is nighttime, then the illuminators 110 are turned on to illuminate the runway(s) 210, taxiways 220 and ramps 230.

At step 704, the cameras 120 collect imagery. Analog data are provided to broadband transmitter 130. Transmitter 130 transmits the analog data to wideband receiver 170. The analog data are transformed to digital data in ADC 504. Frame grabber 506 collects individual frames and transmits the frames to on-site processor 180.

At step 706, Processor 180 determines whether the movement is an arrival, a departure, or a touch-and-go. If an arrival, departure or touch-and-go is detected, the image is stored locally in hard drive of the on-site processor.

At step 708, on-site processor 180 transmits the image data to central processor 190.

At step 709, the event data and image data are stored in the central processor.

At step 710, the central processor performs optical character recognition (OCR) to determine the tail number of the aircraft 202.

At step 712, the central processor correlates the tail number with entries in other aircraft databases having the same tail number.

At step 714, the central processor generates reports summarizing the data for a given airport and time period.

At step 716, data may also be sent to the “SUPERUNICOM™” (or other real time alarm system) to generate audible alerts, as appropriate.

Hardware Components

Camera: The exemplary camera 120 is an industrial grade high sensitivity, high-resolution black and white video camera that incorporates an interline transfer method ½″ charge coupled device (CCD) with approx. 410,000 picture elements (811H×508V, 768H×494V effective). This camera produces a picture with more than 570 lines of resolution and has a minimum light requirement of 0.07 lux with F1.2 lens and a S/N ratio of more than 50dB. The video output level is 1.0Vp-p (75 ohms, composite) with a BNC type connection. The video camera is C-mount and CS-mount selectable with a C mount adapter (included). It has an auto iris connector on the side of the camera body to permit connection of DC: iris control coil only type lenses (galvanometric iris without amplifier) and VIDEO: DC power and video signal supply auto-iris type lenses (with amplifier) type lenses.

Because the videocam imaging chip (not shown) of exemplary cameras 120 is highly sensitive to not only visible but near infrared light, it can be used for both daytime and nighttime viewing. An infrared illuminator 110 is provided during nighttime operations. The light from exemplary illuminator 110 is not only eye-safe, it is invisible to the human eye.

The video camera 120 has an available Backlight compensation circuit; Electronic/Auto Iris and Flange back adjustment. The camera 120 has both internal and external sync (VS) (75 Ohms/high impedance, selectable internally) capabilities, automatic selection.

Power requirement for the exemplary video camera 120 is 12 V DC. It consumes 1.8 W (approx. w/ Auto Iris lens) up to 4 watts power consumption with auto iris lens. The video camera 120 is constructed of a durable metal cabinet, providing magnetic and electrostatic shielding. It features solid-state components to resist shock and vibration. The operating range of the video camera is over a temperature range from −10° C. to +50° C. and humidity within 90% relative humidity. The video camera 120 is equipped with an auto iris lens and manual variable focal length from 8 mm to 48 mm designed for a ½″ format camera. The operating temperature of the lens is −20° C. to +50° C.

The exemplary camera 120 and auto iris lens (not shown) are installed in a NEMA 4 enclosure of die cast and extruded aluminum construction. The enclosure of camera 120 is equipped with a sun shroud to prevent overheating during the summer months. A field installed heater, blower, defroster options may optionally be included. The standard power box (described below) is sized to handle these options without further modification.

The exemplary system 100 has no mechanical or moving parts, so that reliability is high. The maturity of the component technology is reflected in its low cost and high reliability and promises a cost effective life cycle product which is easy to install and maintain at a vast number of airports virtually regardless of size, complexity or environmental factors.

Wireless Telemetry System: The wireless telemetry system 130 is a professional quality system designed for sending composite NTSC signals using 5.8 GHz wireless technology. The telemetry system 130 has 12 user-selectable channels. The power draw on the transmitter 130 is 220 mA maximum. The standard receiver antenna gain ensures communications up to 1 mile unobstructed line of sight. Transmission distances of up to 7 miles are achievable with an upgraded receiver antenna. The transmitter receiver pair is housed in a NEMA 4R rated enclosure. The operating temperature of the system is −20 to +70° C.

Infrared Illuminator: The camera imaging chip is designed to be responsive in low light conditions and thus provides imagery through dusk, on bright moonlit nights, and similar conditions. An illuminator 110, such as an infrared illuminator, is used during very low or no light conditions. Illuminator 110 is used when nighttime illumination of the tail number of an aircraft 202 is required. The exemplary infrared illuminator is equipped with an IR filter that transmits only 0.01 percent of the visible light spectrum, resulting in a beam that is invisible to the human eye. A 500 watt narrow spot lamp is used in order to distinguish airplane tail numbers to a distance of 200 feet. The average lamp life is 3,500 hours at rated voltage (lamps sensitive to change in voltage). The infrared illuminator is rated at NEMA 3R and has an operating range of −20 to +50C. It is mounted on a frangible pole and powered off the 120 VAC runway lighting system 150.

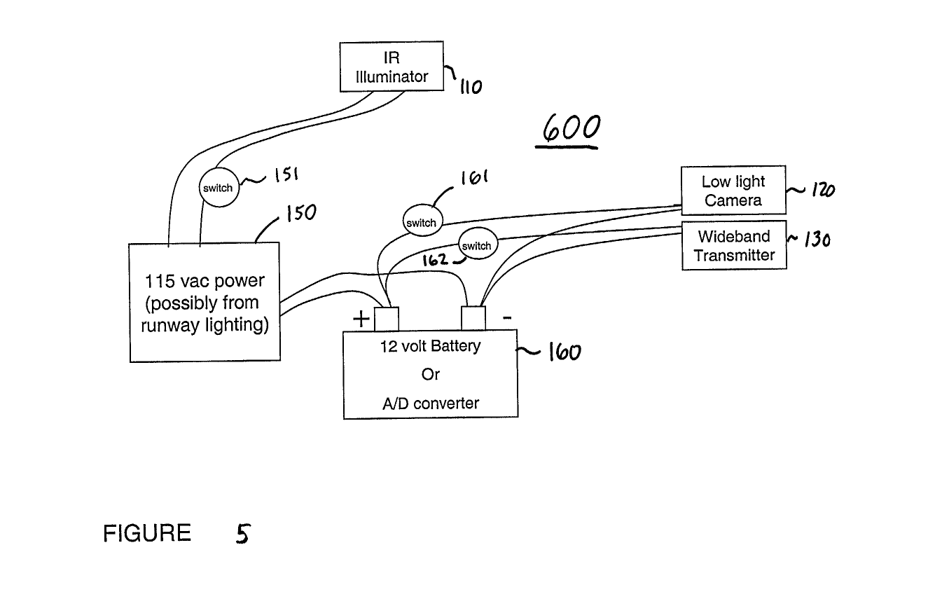

FIG. 5 is a detailed diagram of the power subsystem 600. The power subsystem 600 is designed for battery operation for 20 hours continuous over the stated environmental conditions. All cameras are powered 24 hours a day, 7 days a week. The preferred embodiment provides 115 VAC power to the illuminator 110, and DC power to the camera 120 and transmitter 130. The runway lights 150 can be used to provide AC power in most climates. A battery 160 can be used to power the transmitter 130 and camera 120. The battery 160 would be recharged during the night from the VAC off the runway lights. The batteries 160 are recharged in 4 hours or less from the 6-amp runway light circuit 150. The power subsystem is housed in a NEMA 4 fiberglass enclosure. Two 12-volt lead acid batteries 160 are coupled in series to provide a 24-volt bus. These batteries are charged with a tandem 12-volt charger that provides independent charge control and temperature compensation. The 24-volt bus powers an optional camera heater (not shown) directly. Additionally 12-volts are derived from a dual voltage DC-to-DC converter to power the camera 120 and telemetry transmitter 130. This voltage converter maintains a regulated output even as the battery discharges, allowing operation down to near full discharge of the batteries. Thermal insulation may be included to allow the storage of heat dissipated by the charging system at night. This feature maintains the batteries' operating temperature during cold weather operation and eliminates the need for a dedicated battery heater. The exemplary housing dimensions are 18 inches high by 16 inches wide by 10 inches deep. The housing may have a gasketed door to allow field servicing. With the camera 120 mounted on top, the unit maintains a profile of less than 66 cm (26 inches) from the ground. An inline power filter protects the camera and telemetry system from over voltage, should lightning strike the airport's lighting system.

An “L” shaped backing plate may mount directly to two frangible poles providing a vertical surface to mount the power supply box and a horizontal surface to mount the camera housing, and telemetry transmitter antenna. The backing plate may be made from 0.125″ aluminum alloy with dimensions slightly larger than the power supply box. Mounted as an inverted “L,” the plate will envelope the power supply box on the top and backside, providing a shelf to mount the camera and telemetry system above the power supply. Other mechanical mountings may be readily constructed by those of ordinary skill in the art.

The central processor 190 can monitor the on-site processor 180 using commercially available software such as “pcAnywhere™”, marketed by Symantec Corporation of Cupertino, Calif.

In the preferred embodiment, the software used in this system is the Tri-Space Airport Landing Information Software (ALIS) suite. ALIS includes an ALISCam client to drive the cameras 120, ALISsrv server to implement functions of the on-site processor 180, and ALISView to implement the event log annotation functions of central processor 190.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An automated method for detecting at least one aircraft, comprising the steps of:
(a) automatically detecting a movement of at least one aircraft within the area, regardless of a time of day when the movement occurs;
(b) forming at least one image of the aircraft when the movement is detected;
(c) automatically identifying a tail number of the at least one aircraft based on alphanumeric data in the least one image; and
(d) automatically storing the tail number of the aircraft and data characterizing the aircraft in a database.

2. The method of claim 1, further comprising, before step (a), the step of illuminating an area through which the aircraft passes, at least during nighttime, with at least one light from the group consisting of visible light and near infrared light;

3. The method of claim 1, further comprising automatically invoicing an owner of the aircraft for use of a facility in which the aircraft is detected.

4. The method of claim 1, wherein step (b) includes collecting video data using at least one video camera.

5. The method of claim 4, wherein step (b) further includes forming the image using a frame grabber.

6. The method of claim 4, wherein step (a) includes detecting the movement based on a change in video data collected by the video camera.

7. The method of claim 1, wherein step (c) includes performing optical character recognition in a processor.

8. The method of claim 1, wherein step (d) further comprises storing in the database at least one of the group consisting of a flight identifier, a time of day when the movement is detected, an identification of whether the movement is an arrival or a departure, a runway identifier, a flight class, a carrier name, a type identifier of the aircraft, a model number of the aircraft, a passenger capacity of the aircraft, and a type of engine of the aircraft.

9. A system for detecting at least one aircraft, comprising:
at least one camera capable of providing an image of the at least one aircraft;
means for detecting when the at least one aircraft moves;
means for identifying a tail number of the at least one aircraft based on alphanumeric data the image;
a storage medium that stores the tail number of the aircraft and the image when the detecting means detects movement of the aircraft.

10. The system of claim 9, further comprising at least one illuminator capable of providing at least one light from the group consisting of visible light and near infrared light,
wherein said video camera is at least capable of providing a nighttime image of the at least one aircraft if the aircraft is illuminated by the at least one illuminator.

11. The system of claim 10, wherein the illuminator provides near-infrared light.

12. The system of claim 9, further comprising means for automatically invoicing an owner of the aircraft for use of a facility in which the aircraft is detected.

13. The system of claim 9, wherein the camera is a video camera capable of detecting visible and near-infrared light.

14. The system of claim 9, wherein the storage means includes a database that stores data representing at least one of the group consisting of a flight identifier, a time of day when the movement is detected, an identification of whether the movement is an arrival or a departure, a runway identifier, a flight class, a carrier name, a type identifier of the aircraft, a model number of the aircraft, a passenger capacity of the aircraft, and a type of engine of the aircraft.

15. The system of claim 9, further comprising a central processor containing the tail number identifying means.

16. The system of claim 15, wherein the central processor includes means for correlating the tail number of the aircraft with information about the aircraft contained in a government or proprietary database.

17. A computer readable medium containing computer program code, wherein when said computer program code is executed on a computer processor, the computer program code causes the processor to perform an automated method for detecting at least one aircraft, comprising the steps of:
(a) automatically detecting a movement of at least one aircraft within the area, regardless of a time of day when the movement occurs;
(b) forming at least one image of the aircraft when the movement is detected;
(c) automatically identifying a tail number of the at least one aircraft based on alphanumeric data in the least one image; and
(d) automatically storing the tail number of the aircraft and data characterizing the aircraft in a database.

18. The computer readable medium of claim 17, wherein the computer program code causes the processor to automatically invoice an owner of the aircraft for use of a facility in which the aircraft is detected.

19. The computer readable medium of claim 17, wherein step (b) includes collecting video data using at least one video camera.

20. The computer readable medium of claim 19, wherein step (b) further includes forming the image using a frame grabber.

21. The computer readable medium of claim 19, wherein step (a) includes detecting the movement based on a change in video data collected by the video camera.

22. The computer readable medium of claim 17, wherein step (c) includes performing optical character recognition in a processor.

23. The computer readable medium of claim 17, wherein step (d) further comprises storing in the database at least one of the group consisting of a flight identifier, a time of day when the movement is detected, an identification of whether the movement is an arrival or a departure, a runway identifier, a flight class, a carrier name, a type identifier of the aircraft, a model number of the aircraft, a passenger capacity of the aircraft, and a type of engine of the aircraft.
